(19) United States
(12) Patent Application Publication
(10) Pub. No.: US 2023/0089493 A1
(43) Pub. Date: Mar. 23, 2023

(54) CONFIGURABLE SERVICE TIMES FOR ON-DEMAND TRANSPORTATION

(71) Applicant: goBrands, Inc., Philadelphia, PA (US)

(72) Inventors: Prachie Banthia, San Francisco, CA (US); Brett Bavar, San Francisco, CA (US); Kevin Patrick Renner, San Francisco, CA (US)

(73) Assignee: goBrands, Inc., Philadelphia, PA (US)

(21) Appl. No.: 17/799,415

(22) PCT Filed: Feb. 10, 2021
(86) PCT No.: PCT/US2021/017413

§ 371 Date: Aug. 12, 2022

Related U.S. Application Data
(60) Provisional application No. 62/977,081, filed on Feb. 14, 2020.
(60) Provisional application No. 63/044,336, filed on Jun. 25, 2020.

(51) Int. Cl. G06Q 10/0631; G06Q 10/20; G06Q 50/30; G01C 21/34

(52) U.S. Cl. CPC G06Q 10/06315; G06Q 10/20; G06Q 50/30; G01C 21/34; G07B 15/02

(57) ABSTRACT

Systems and methods for dispatching a fleet of vehicles includes determining a total time expectation for a trip for a vehicle. The total time expectation includes a service time expectation that is different from a travel time for the first trip. The method also includes receiving one or more requests for a new trip and determining, based at least in part on the total time expectation for the trip, whether to assign the new trip to the vehicle. In some embodiments, the service time expectation is determined based on historical data or a user preference. In some embodiments, the service time expectation is generated by a model that is trained using historical data.

### TECHNICAL FIELD

The disclosed embodiments relate generally to systems and methods for providing transportation (e.g., on demand and otherwise) with customizable service times.

### BACKGROUND

Recent years have seen a rapid growth in on-demand transportation. Today, commuters have a wide variety of options in on-demand transport, including ride-hailing, car-sharing, as well as traditional on-demand transportations such as limousine and taxi services. Additionally, such services can be provided by a driver controlling a vehicle or with the use of autonomous vehicles (AVs). An important aspect of a successful fleet of on-demand vehicles is fast and efficient fleet dispatching and routing.

As developers build core autonomy technology and start to scale their fleets of on-demand transportation vehicles, whether for sale to individual consumers or operating their own ride-sharing fleets, these developers will need effective and efficient dispatching and routing technology. The winners and losers in this race will be determined by which companies operate the most efficient networks with the highest vehicle utilization.

### SUMMARY

Accurate estimates of trip times are crucial to providing effective dispatching and routing for vehicles in a fleet. Different types of on-demand transportation have different requirements and thus, require a fleet organizational system that can be customized based on the characteristics of the fleet as well as the needs of the fleet manager and requirements of each trip. For example, a ride-hail service may take a different amount of time to complete a trip that traverses a same route or travel distance depending on time of day (e.g., traffic conditions) or based on the type of vehicle that is dispatched (e.g., a driver-controlled vehicle versus an autonomous vehicle). Thus, a fleet organizational system that can account for various factors that may contribute to a total trip time leads to more accurate prediction of trip times and therefore results in more efficient routing of vehicles.

Such factors can be accounted for by adding additional and customizable steps to the fleet organizational system in trip planning. For example, a trip plan may include a few fixed steps that are common to all trips, such as “travel time to arrive at pick-up location” and “trip travel time.” Additional steps may be added to such trips, for instance, a “pick-up wait time” or a “post-trip cleaning time” to provide a more accurate estimate of the total trip time by accounting for a duration of trip-related factors or a duration of company-mandated policies (e.g., “must clean car after each trip”) that can be estimated. As described herein, these durations can be specified, for example, by a fleet manager and/or through analysis of historical data.

In accordance with some embodiments, a method of dispatching a fleet of vehicles includes determining a first total time expectation for a first trip for a first vehicle. The first total time expectation includes a first service time expectation (e.g., a configurable service time expectation) that is different (e.g., separate) from a travel time for the first trip. The method also includes receiving one or more requests for a new trip that is different from the first trip, including receiving a requested pick-up location and a requested drop-off location. The method further includes determining, based at least in part on the first total time expectation for the first trip, whether to assign a new trip to the first vehicle, and assigning the new trip to the first vehicle. The method also includes routing the first vehicle to a pick-up location corresponding to the requested pick-up location and routing the first vehicle from the pick-up location to a drop-off location corresponding to the requested drop-off location.

In some embodiments, the method further includes generating an estimated start time (e.g., pick-up time estimate) for the new trip in response to a determination to assign the new trip to the first vehicle. The estimated start time is based at least in part on the first total time expectation for the first trip.

In some embodiments, determining the first total time expectation includes determining the first service time expectation.

In some embodiments, the first service time expectation corresponds to a service type that is selected from the group consisting of: a cleaning time; a re-fueling time; a re-charging time; a repair time; a pick-up wait time; a drop-off wait time; a post-trip review time; and a trip acknowledgement time (e.g., a delay between the driver accepting the trip and starting the trip).

In some embodiments, the method further includes analyzing historical data for a plurality of trips to determine the first service time expectation. Analyzing the historical data includes, for a respective trip of a plurality of trips, observing a respective duration (e.g., 2 minutes) for the service type (e.g., pick-up wait time) and observing a trip characteristic (e.g., morning pick-up before 5 AM) for the respective trip. The method also includes determining a correlation between the trip characteristic (e.g., morning/afternoon/evening) and observed durations (e.g., people take ˜3 minutes in the morning and <1 minute in the afternoon) for the service type (e.g., pick-up wait time). The method also includes determining the first service time expectation for the first trip, where the first service time expectation is based at least in part on a trip characteristic of the first trip.

In some embodiments, the method further includes receiving a plurality of trip characteristics for the first trip. The first service time expectation is determined based on the plurality of trip characteristics of the first trip (e.g., pick-up location is a suburb, drop-off location is an airport, pick-up time is evening).

In some embodiments, the method further includes receiving a trip characteristic for a second trip that is distinct from the first trip. The trip characteristic for the second trip is different from the trip characteristic of the first trip (e.g., the first trip is occurring in Dallas and the second trip is occurring in Toronto). The method also includes determining a second configurable service time expectation (e.g., second service time expectation) for the second trip and the second configurable service time expectation is based at least in part on the trip characteristics of the second trip. The first service time expectation and the second configurable service time expectation correspond to a same service type (e.g., drop-off wait time), and the second configurable service time expectation is different from the first service time expectation (e.g., has a different duration).

In some embodiments, the first service time expectation is determined based on historical data (e.g., historical data that includes observed service times tagged with different characteristics, such as different pick-up/drop-off location, time of day, etc., such that the different characteristics can be correlated to the historically observed service times.).

In some embodiments, the first service time expectation is determined based on real-time data (e.g., real-time data may indicate a surge in demand for on-demand transportation and in response to the change in demand shown in the real-time data, a service time expectation may be changed).

In some embodiments, the first service time expectation is generated by a model that is trained using historical data.

In some embodiments, the first service time expectation is determined from a user preference.

In some embodiments, the method further includes receiving a first user preference that indicates a first duration for the first configurable service time expectation for vehicles of a first fleet and assigning vehicles of the first fleet to have the first configurable service time expectation corresponding to the first duration. The method also includes receiving a second user preference indicating a second duration for a second configurable service time expectation for vehicles of a second fleet and assigning vehicles of the second fleet to have the second configurable service time expectation corresponding to the second duration. The second configurable service time expectation corresponds to a same service type as the first configurable service time expectation and the second duration is different from the first duration.

In some embodiments, the method further includes receiving a first user preference that indicates a first duration for a first service type for vehicles of a first fleet and assigning vehicles of the first fleet to have a first service time, corresponding to the first duration, for the first service type. The method also includes receiving a second user preference that indicates a second duration, different from the first duration, for the first service type for vehicles of the first fleet. The method also includes updating the first service time for the first fleet so that the first service time corresponds to the second duration.

In some embodiments, the method further includes determining an estimated end time for the first trip and the estimated end time is determined based at least in part on the total service time expectation.

In some embodiments, the method further includes routing a plurality of vehicles in a fleet, which includes routing the first vehicle based on characteristics of the new trip (e.g., based on the service time expectations corresponding to the characteristics of the new trip).

In some embodiments, routing a plurality of vehicles in the fleet includes routing a second vehicle after assigning the new trip to the first vehicle.

Additionally, other customizable features may be included in order to aid a fleet organizational system in trip planning. For example, a vehicle may query a set of curated parking spots to find parking spots that are available to be used as pick-up or drop-off locations in order to provide more efficient pick-up and drop-off experiences. In some cases, such as in a busy area of a city or on a big road, it may be difficult for ride-hail and ride-share services to find a spot to park in order to pick-up or drop-off a passenger. In some cases, such as with a human driver, the driver may resort to dangerous or illegal maneuvers such as double parking on a street or stopping in front of a no-stopping area or a fire hydrant in order to pick-up or drop-off a passenger. Such maneuvers are undesirable since they pose an unnecessary safety risk. At the same time, eliminating such maneuvers may negatively affect route planning due to the unpredictability of available spots for stopping. Allowing customizable pick-up and drop-off locations mitigates this unnecessary risk to the safety of passengers, drivers, and vehicles, as well as improves efficiency in pick-up and drop-off times, thereby providing an improved pick-up and drop-off experience. As described herein, these customized pick-up and drop-off locations can be specified, for example, by a fleet manager through a curated set of known parking spots.

In accordance with some embodiments, a method of dispatching a fleet of vehicles includes receiving a requested pick-up location for a first passenger of a new trip, querying a curated set of parking spots to find one or more first parking spots corresponding to the requested pick-up location, and assigning a first parking spot of the one or more first parking spots as the pick-up location for the first passenger. The method also includes receiving a requested drop-off location for the first passenger of the new trip, querying the curated set of parking spots to find one or more second parking spots corresponding to the requested drop-off location, and assigning a second parking spot of the one or more second parking spots as the drop-off location for the first passenger. The method further includes assigning a vehicle of the fleet of vehicles to the new trip and routing the vehicle for the first trip, including routing the vehicle to pick-up the first passenger at the assigned pick-up location and routing the vehicle to drop-off the first passenger at the assigned drop-off location.

In some embodiments, the curated set of parking spots includes parking spots that have been identified based on historical data.

In some cases, the method includes determining whether a respective parking spot is available to be used as a pick-up or drop-off location. For example, historical data corresponding to a respective parking spot may be used to determine a probability (e.g., likelihood) that the respective parking spot is available (e.g., not occupied, not in use, accessible).

In some embodiments, the curated set of parking spots includes parking spots that have been identified by one or more images captured by a vehicle of the fleet of vehicles.

In some embodiments, the method further includes selecting the first parking spot of the one or more first parking spots as the pick-up location for the first passenger and selecting the second parking spot of the one or more second parking spots as the drop-off location for the first passenger. The first parking spot is selected based at least on a proximity of the first parking spot to the requested pick-up location and the second parking spot is selected based at least on a proximity of the second parking spot to the requested drop-off location.

In some embodiments, each parking spot of the curated set of parking spots includes one or more characteristics. The first parking spot is assigned based at least on a characteristic of the first parking spot and the second parking spot is assigned based at least on a characteristic of the second parking spot. Some embodiments of the present disclosure provide a computer system (e.g., a server system such as first server system 400 or second server system 402 shown in FIG. 4B), comprising one or more processors and memory storing one or more programs. The one or more programs store instructions that, when executed by the one or more processors, cause the computer system to perform any of the methods described herein.

Some embodiments of the present disclosure provide a non-transitory computer readable storage medium storing instructions that, when executed by a computer system having one or more processors, cause the computer system to perform any of the methods described herein.

These embodiments improve fleet organizational systems by providing additional customizable steps that can be added to a trip, allowing for more accurate trip time estimates used in vehicle dispatching and routing systems. Thus, such embodiments improve the accuracy, effectiveness, and efficiency of fleet organizational systems by enabling more accurate trip time predictions.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings.

FIG. 1 is a block diagram illustrating a trip timeline in accordance with some embodiments.

FIGS. 2A-2H illustrate a flowchart of a method for assigning trips to a vehicle, in accordance with some embodiments.

FIG. 3A illustrates a timeline with customizable steps and times, in accordance with some embodiments.

FIG. 3B illustrates updating customizable steps and times in the timeline shown in FIG. 3A based on historical information, in accordance with some embodiments.

FIGS. 4A-4B are block diagrams illustrating an architecture of a vehicle routing engine, in accordance with some embodiments.

FIG. 5 is a block diagram illustrating a client-server environment, in accordance with some embodiments.

### DETAILED DESCRIPTION

These systems and methods improve fleet dispatching and routing systems for on-demand transportation by providing better estimates for trip times. In routing and dispatching a fleet of vehicles, certain service times need to be taken into consideration. Examples of such service times include cleaning time, re-fueling time, how long a vehicle will wait to pick-up a passenger (e.g., a maximum allowable wait time), and so on. These service times effect not just fleet-wide estimates of trip time (estimated time of arrival, estimated time of departure), etc., but also routing. For example, in some embodiments, a ride sharing network takes into account service times in determining which vehicles to route to which passengers, and along which routes (since assigning a passenger to any particular vehicle affects the routes of other vehicles currently operating in the fleet). Moreover, the present embodiments allow these service times to be configurable, e.g., by a user (e.g., a fleet manager) or through machine learning, through the use of historical data, and/or through the use of real-time data. In some embodiments, the service times can be configured differently for different trip characteristics (time of day, location, etc.), differently for different fleets, and or different for different vehicles or classes of vehicles within the fleets. In some embodiments, a fleet of vehicles is routed and/or dispatch decisions for the fleet of vehicles are made in accordance with the configurable (or configured) service times.

By providing such fleet organizational systems with more accurate and/or configurable service times, dispatching and routing systems can more efficiently plan out current trips and future trips (including pre-planned trips as well as new trip requests). Thus, the systems and methods described herein provide more accurate trip time predictions or routing, thereby improving the efficiency and effectiveness of dispatching and routing systems for on-demand transportation fleets. More efficient and effective dispatch and routing of vehicle fleets results in less wear and tear on vehicles, increased fuel economy and/or battery life, etc.

Note that, although some embodiments are described herein with respect to on-demand transportation, certain principles of the present disclosure are also applicable to scheduled transportation (e.g., scheduled rides for humans, delivery of goods and services, etc.)

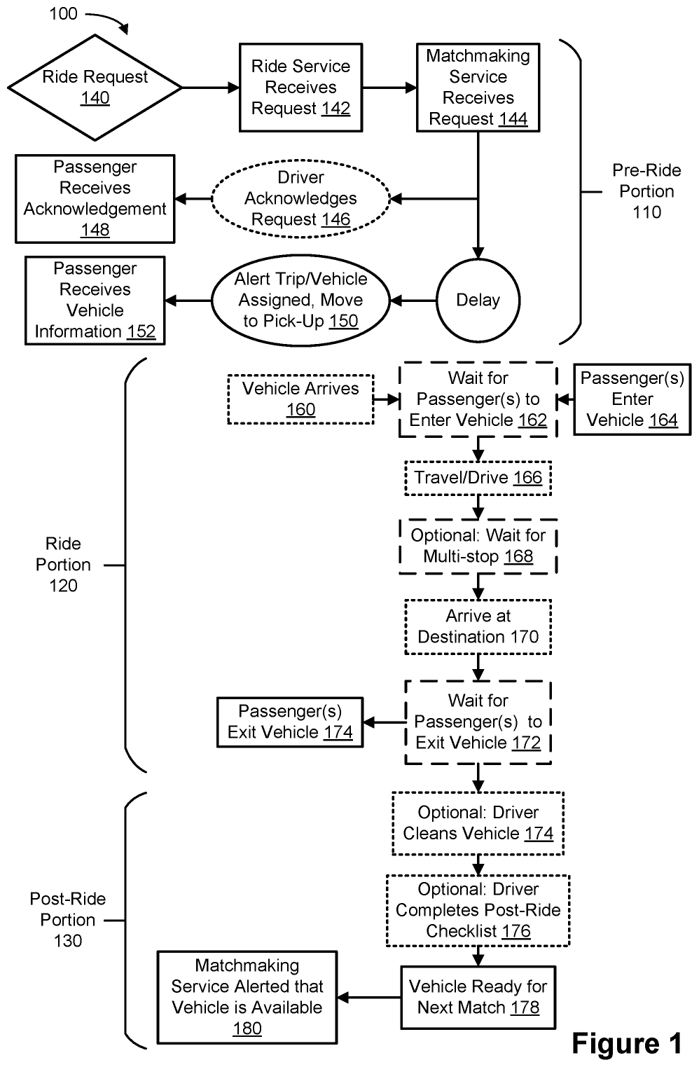

FIG. 1 is a block diagram illustrating a trip timeline 100 in accordance with some embodiments. The steps shown in FIG. 1 can be separated into three categories: 1) steps that remain fixed (e.g., unchanged), shown with solid lines; 2) steps that are affected by a driver's speed (e.g., a driver's cleaning speed, driving speed), shown with dotted lines; and 3) steps that are variable due to preferences of the fleet manager (e.g., steps that may be customized), shown with dashed lines. Optional steps, such as a multi-stop, which may exist for some types of rides but not others (e.g., multi-destination rides such as ride-share or car-pool rides will require a multi-stop step but single destination rides do not require an additional stop or multi-stop step), are notated.

A trip is broken down into three portions: a pre-ride portion 110 corresponding to dispatching, assigning, and acknowledgement of the trip, a ride portion 120 corresponding to interactions that include the passenger(s) (e.g., picking up, driving, and dropping off the passenger(s), and a post-ride portion 130 corresponding to post-ride steps such as cleaning or refueling of the vehicle before a next trip can begin or be assigned or accepted.

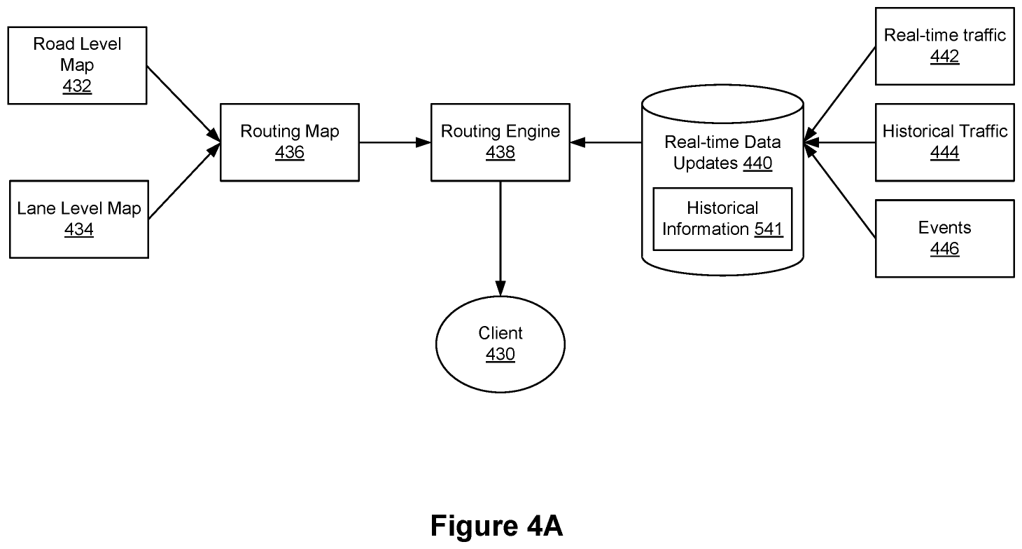

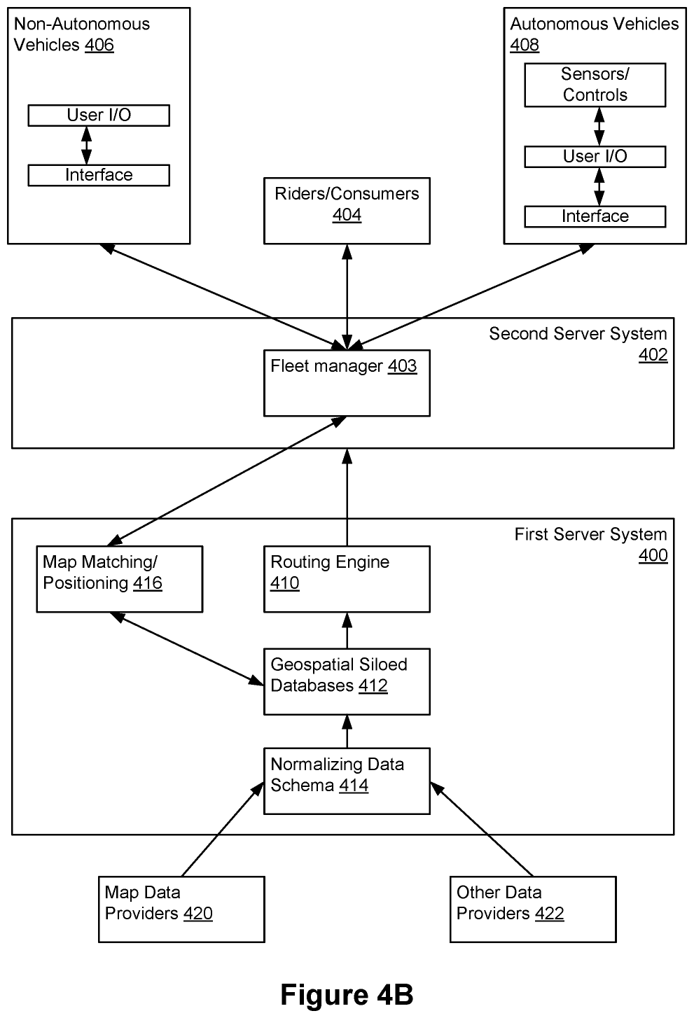

As shown in FIG. 1, a ride request 140 from a passenger (e.g., rider(s), passenger(s) 404 shown in FIG. 4B) triggers the beginning of a trip. In the pre-ride portion 110 of the trip, the ride request 140 is received by the ride service 142 and is forwarded to a matchmaking service 144 (e.g., a dispatch service or system). The matchmaking service 144 forwards the ride request 140 to a driver who acknowledges 146 (e.g., accepts or declines) the ride. Once the ride is accepted, the ride request is forwarded to a passenger who receives the acknowledgement 148 (e.g., “your ride has been confirmed”). The matchmaking service 144 also sends an alert to the assigned driver or vehicle 160. The alert may include information such as a pick-up location so that the driver may begin the trip (e.g., move to the pick-up location 150). The alert is forwarded to a passenger showing information regarding the assigned vehicle 152. In some cases, the passenger may also receive the current location of the vehicle as well as an estimated time of arrival of the vehicle and the pick-up location.

In the ride portion 120 of the trip, the vehicle arrives (step 160) at the pick-up location and waits for the passenger to enter the vehicle (step 162). In some embodiments, the vehicle has a maximum allowable wait time for the passenger to arrive at the vehicle, which is an example of the configurable service times described herein. Once the passenger enters the vehicle 164, the travel portion 166 of the trip (e.g., driving) begins. In some cases, such as in a multi-stop ride, the trip includes an additional step 168 corresponding to one or more additional stops during the trip. Once the vehicle arrives at the final destination of the trip (step 170), the vehicle must wait for the passenger to exit the vehicle (step 172) before beginning the post-ride portion of the trip (another example of a configurable service time).

The post-ride portion 130 of the trip includes steps after the passenger exits the vehicle (step 174) before the vehicle is ready to accept or begin another trip.

In some embodiments, as shown, a trip may include additional optional steps (e.g., optional steps 174 and 176). For example, a first fleet (e.g., such as fleet manager 403 shown in FIG. 4B) may have a policy that requires all vehicles in the fleet to be cleaned between trips. Thus, a trip timeline for trips taken by vehicles of the first fleet includes a cleaning step 174 (another example of a configurable service time). In contrast, a second fleet (e.g., similar to fleet manager 403 shown in FIG. 4B) may not have a cleaning policy and thus, a trip timeline for trips taken by vehicles of the second fleet may not include a cleaning step. In another example, a third fleet (e.g., such as fleet manager 403 shown in FIG. 4B) may require that drivers complete a post-ride checklist after every ride. Thus, trips taken by vehicles of the third fleet may include a post-ride completion step 176 before the vehicle is ready for a new trip 178. Once the vehicle is ready for a new trip, the matchmaking service is alerted that the vehicle is available 180.

In some embodiments, a fleet manager who manages a fleet of vehicles may choose which steps are included in the timeline for trips assigned to and completed by vehicles of the fleet. For example, a fleet manager that manages a first fleet of vehicles may determine that a cleaning step is required for each trip (e.g., after dropping the passenger off and prior to picking up a new passenger for a new trip request). In contrast, a fleet manager that manages a second fleet of vehicles that is distinct (e.g., different from) the first fleet of vehicles may omit the cleaning step between rides.

In some embodiments, a fleet manager can define the trip timeline (e.g., define which steps are included in trip timelines) via a user interface.

In some embodiments, the time allotted for one or more steps within the timeline are customizable by a fleet manager (e.g., via a user interface). For example, a fleet manager may allot 3 minutes to waiting for the passenger(s) to enter the vehicle (step 162).

In some embodiments, the times allotted for one or more steps within the timeline are determined based at least in part on historical information for the fleet of vehicles. For example, historical information regarding trips completed by the fleet of vehicles may indicate that passengers tend to take 2 minutes and 15 seconds to enter a vehicle. Thus, the trip timeline may be adjusted so that 3 minutes is allotted for waiting for passenger(s) to enter the vehicle (step 162).

In some embodiments, the time allotted for one or more steps within the timeline are determined based at least in part on historical information for the fleet of vehicles and can vary based on trip conditions (e.g., time of day, day of week, pick-up location, drop-off location). For example, historical information regarding trips completed by the fleet of vehicles may indicate that passengers tend to take longer (e.g., 3 minutes and 42 seconds) to exit a vehicle when the trip destination is at an airport. Thus, the trip timeline may be adjusted so that 5 minutes is allotted for waiting for passenger(s) to exit the vehicle (step 162) when the trip destination is an airport (or other transportation port such as a train station).

In some embodiments, the time allotted for one or more steps within the timeline is updated as new trips are completed and more data regarding service times for each step is available in the historical information.

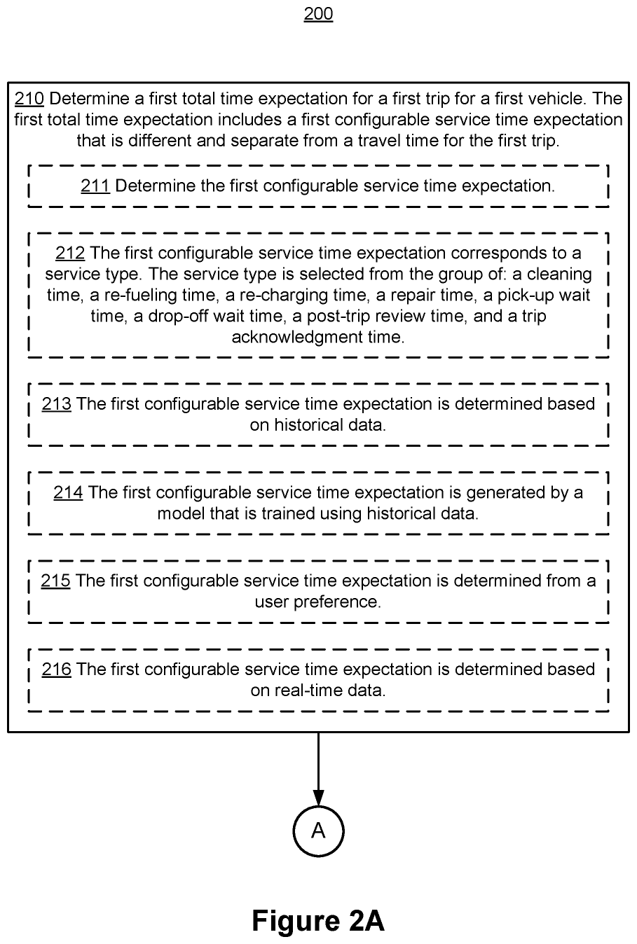

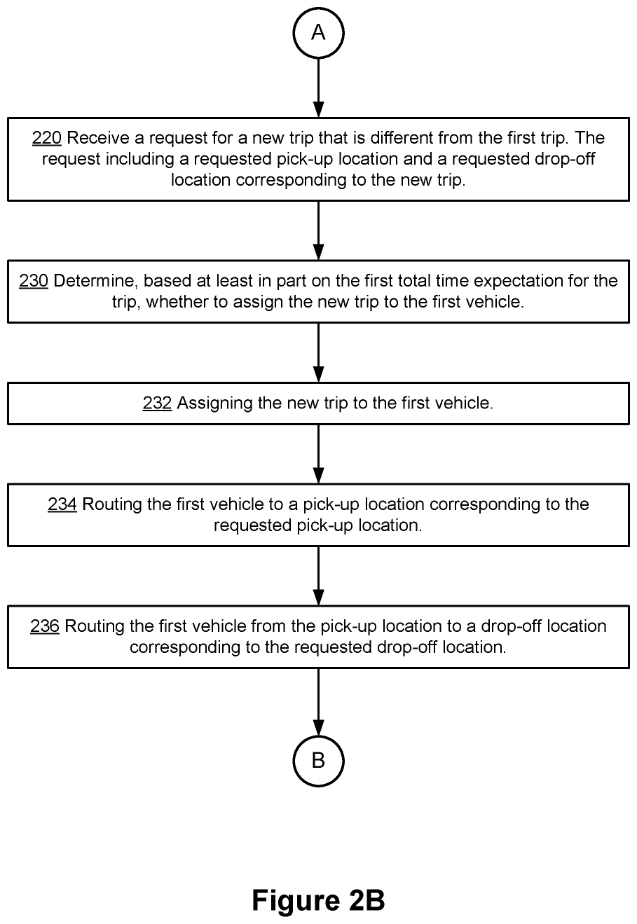

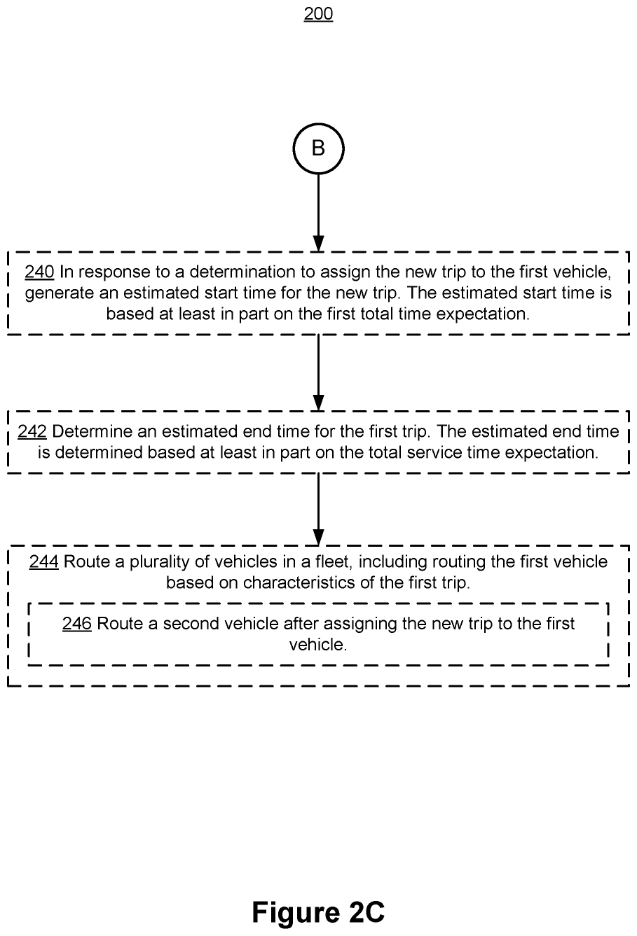

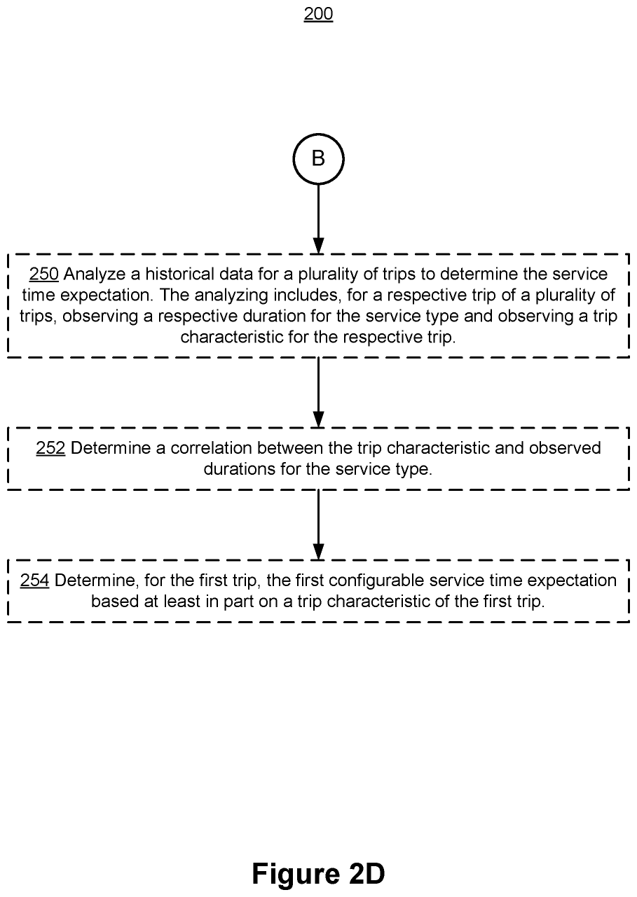

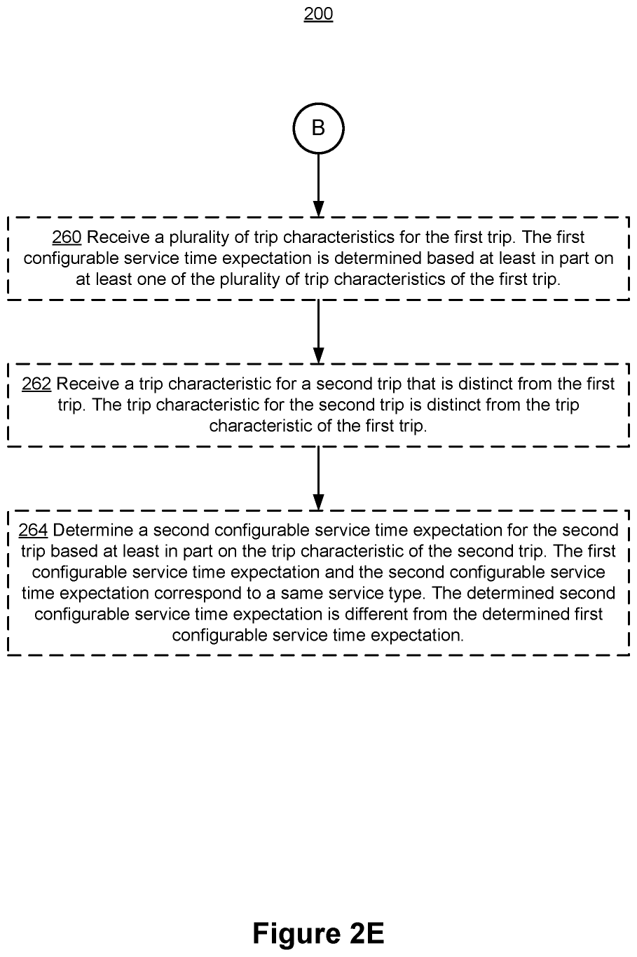

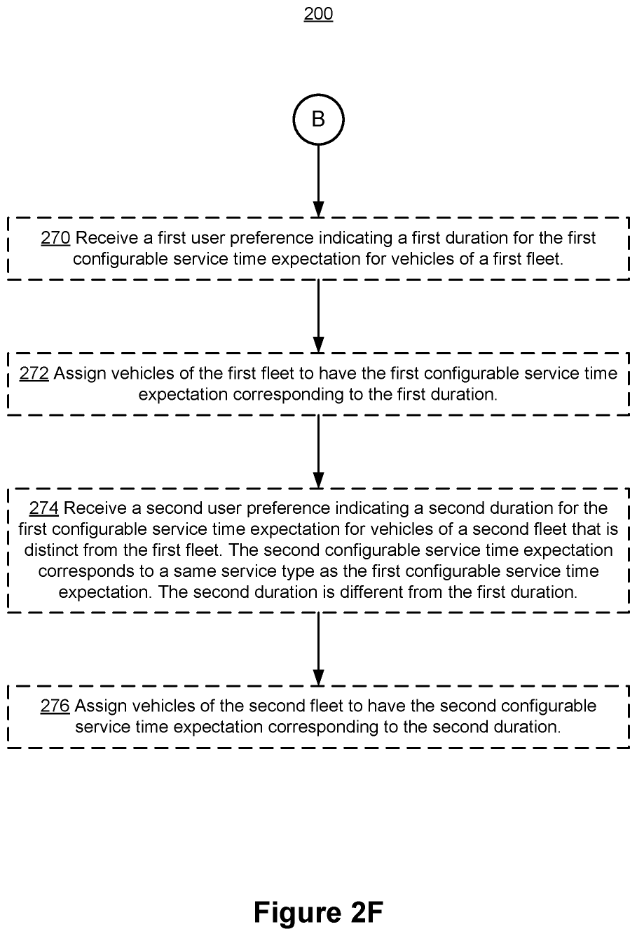

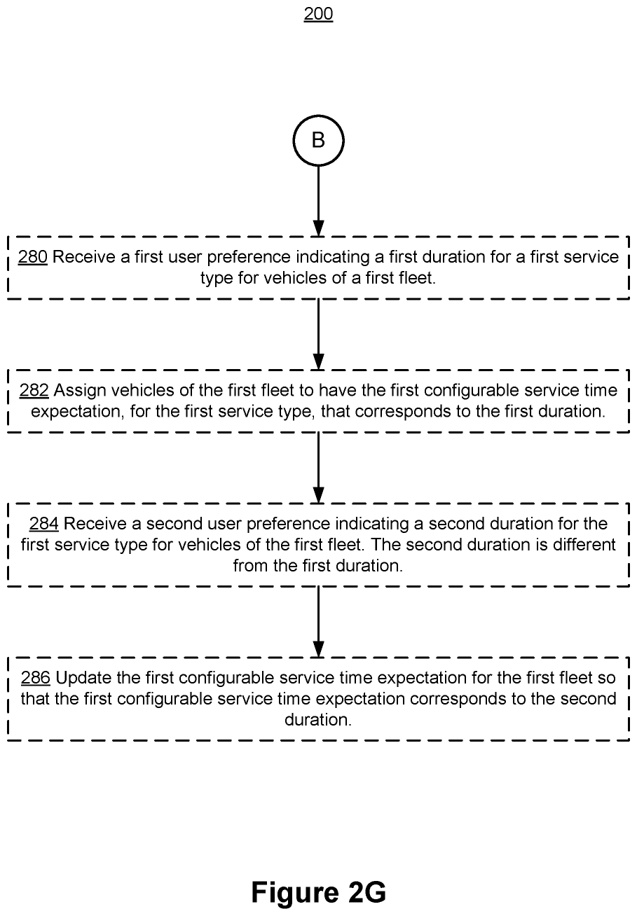

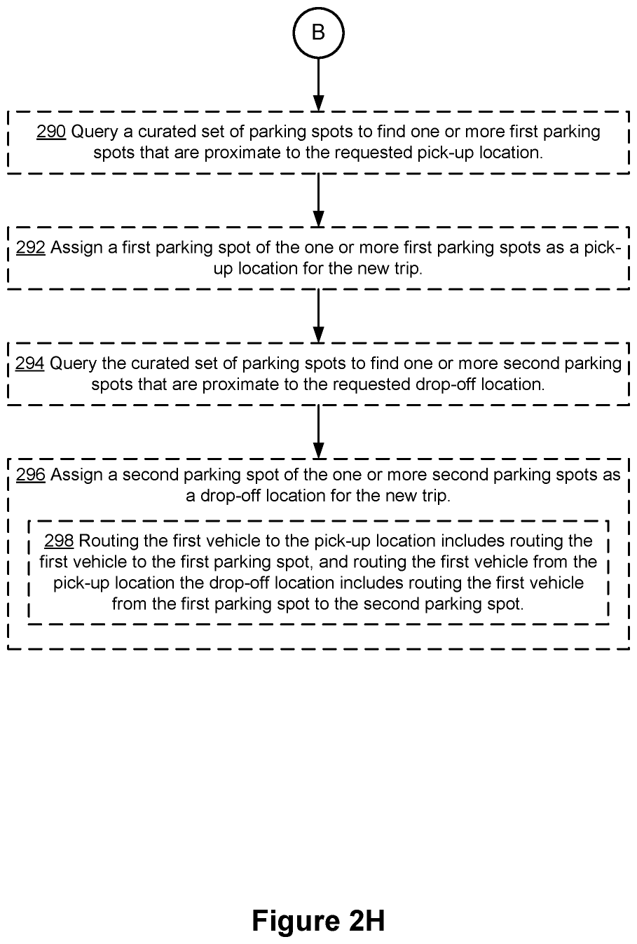

FIGS. 2A-2H show a flow chart of a method 200 of dispatching a fleet of vehicles, in accordance with some embodiments. The method 200 is performed at an electronic device (e.g., a fleet organizational system such as first server system 400 or second server system 402 shown in FIG. 4B, that includes a vehicle dispatching server and/or vehicle routing server). While the following discussion describes implementations where a fleet organizational system performs the steps of the method 200, in other embodiments, one or more (e.g., all) of the steps are performed by another electronic device, such as a vehicle (e.g., a computer system on a vehicle with non-transitory memory storing instructions for executing the method and one or more processors for executing the instructions) or a server system distinct from the vehicle routing server. Moreover, some operations in method 200 are, optionally, combined and/or the order of some operations is, optionally, changed. In some embodiments, some or all of the operations of method 200 are performed automatically (e.g., without human intervention).

Method 200 includes determining (210) a first total time expectation for a first trip for a first vehicle. The first total time expectation includes a first configurable service time expectation (e.g., a first service time expectation) that is different from a travel time for the first trip. The method 200 also includes receiving (220) a request for a new trip that is different from the first trip, including receiving a requested pick-up location and a requested drop-off location corresponding to the new trip. The method 200 further includes determining (230), based at least in part on the first total time expectation for the trip, whether to assign a new trip to the first vehicle. In accordance with a determination to assign the new trip to the first vehicle, the method 200 also includes assigning (232) the new trip to the first vehicle, routing (234) the first vehicle to a pick-up location corresponding to the requested pick-up location, and routing (236) the first vehicle from the pick-up location to a drop-off location corresponding to the requested drop-off location.

For example, a fleet manager may receive a plurality of requests for a new trip, each of which includes a requested pick-up location and a requested drop-off location. In determining which vehicles of the fleet to assign to which trips (or which trips to be assigned to which vehicles), the fleet manager determines the total time expectation for trips that are currently being completed by vehicles of the fleet and assigns vehicles to trips (or assigns trips to vehicles) based at least in part on the determined total time expectation for trips being completed by vehicles of the fleet.

In some cases, the pick-up location is the same as the requested pick-up location. Alternatively, the pick-up location may be different from the requested pick-up location and within a predetermined distance from the requested pick-up location (e.g., within 100 meters, within a city block, within a 3 minute walk).

In some cases, the drop-off location is the same as the requested drop-off location. Alternatively, the drop-off location may be different from the requested drop-off location and within a predetermined distance from the requested drop-off location (e.g., within 50 meters, within a two city blocks, within a 5 minute walk).

In some embodiments, assigning the first vehicle to the new trip includes selecting the first vehicle from a fleet of vehicles and assigning the first vehicle to the new trip. For example, for each trip request that is received, a dispatch manager or dispatch service selects and assigns a vehicle of the fleet of vehicles to the received trip request.

In some embodiments, the method 200 also includes determining (211) the first configurable service time expectation.

In some embodiments, (212) the first configurable service time expectation corresponds to a service type. The service type is selected from the group consisting of: a cleaning time, a re-fueling time, a re-charging time, a repair time, a pick-up wait time, a drop-off wait time, a post-trip review time, and a trip acknowledgment time.

In some embodiments, (213) the first configurable service time expectation is determined based on historical data.

In some embodiments, (214) the first configurable service time expectation is generated by a model (e.g., a neural network) that is trained using historical data. For example, historical data that includes trip characteristics (e.g., tagged with trip characteristics) and recorded durations for one or more service types can be used to train one or more models to predict service time expectations for the service types based on the trip characteristics. In some embodiments, the predicted service time expectations for the service types based on the trip characteristics are applied to a new trip. In some cases, machine learning may be employed to train the one or more models.

In some embodiments, (215) the first configurable service time expectation is determined from a user preference. For example, a user (e.g., a fleet manager 403 shown in FIG. 4B) may provide a fixed duration for a service type, such as a fixed 5 minute duration for cleaning. In a second example, a user may provide a duration of 2 minutes for a post-ride survey. In some cases, a user may provide a plurality of durations for a same service type based on trip characteristics. For example, a user may provide a duration of 2 minutes for a pick-up wait time for trips in the morning and a duration of 4 minutes for a pick-up wait time for trips in the evening.

In some embodiments, (216) the first configurable service time expectation is determined based on real-time data. For example, real-time data tracking demand for on-demand transportation may show an increase in demand. In response to the increase in demand shown in the real-time data, a service time expectation may be shortened to allow more vehicles to be available for rides or to allow vehicles to have a faster turn-around time between rides.

In some embodiments, the first vehicle is routed to the pick-up location corresponding to the requested pick-up location after the first vehicle completes the first trip.

In some embodiments, the new trip and the first trip are part of a same car-pool. In such cases, the first vehicle may be re-routed (e.g., the fleet manager may update routing of the first vehicle) to the pick-up location corresponding to the new trip before completing the first trip. In such cases, the method 200 further includes updating the first total time expectation for the first trip to account for the additional steps corresponding to adding the new trip to the vehicle's route.

In some embodiments, the method 200 includes, generating (240) an estimated start time for the new trip in response to a determination to assign the new trip to the first vehicle. The estimated start time is based at least in part on the first total time expectation.

In some embodiments, the method 200 includes determining (242) an estimated end time for the first trip. The estimated end time is determined based at least in part on the total service time expectation.

In some embodiments, the method 200 includes routing (244) a plurality of vehicles in a fleet, including routing the first vehicle based on characteristics of the first trip. In some embodiments, the fleet of vehicles is routed according to any of the routing methods described in U.S. Pat. No. 10,563,993, which is incorporated by reference in its entirety. In some embodiments, the fleet of vehicles is routed using a state graph representation for a plurality of passengers and the fleet. The various service types described herein are represented as states in the state graph representation, and the service time expectations are applied to the state graph such that the cost of traversing a particular path through the state graph is based in part on the service time expectations.

In some embodiments, the method 200 includes routing (246) a second vehicle after assigning the new trip to the first vehicle. For example, as noted above, a fleet of vehicles is routed using the configurable service time expectations described herein.

In some embodiments, the method 200 includes analyzing (250) historical data for a plurality of trips to determine the service time expectation. The analyzing includes, for a respective trip of a plurality of trips, observing a respective duration for the service type and observing a trip characteristic for the respective trip. The method 200 also includes determining (252) a correlation between the trip characteristic and observed durations for the service type, and determining (254) the first configurable service time expectation for the first trip. The first configurable service time expectation for the first trip is based at least in part on a trip characteristic of the first trip. For example, 975 durations may be recorded for a drop-off wait time service type, each of the recorded durations corresponding to a drop-off wait time for a distinct trip (e.g., 975 trips in total). In addition to the duration of the drop-off wait time for each trip, one or more trip characteristics may also be recorded for each trip. For example, for a first trip, trip characteristics may include pick-up location type (e.g., suburb), drop-off location type (city), pick-up time: 8:35 AM, and rider demographics (e.g., male, 28 years old, special assistance needed: no). In a second example, for a second trip, trip characteristics may include pick-up location type (e.g., suburb), pick-up time: 11:55 AM, and rider demographics (e.g., male, 72 years old, special assistance needed: yes).

In some embodiments, operations 250-254 can be performed for a plurality of distinct service types (e.g., the service types described above). For example, in addition to recording trip characteristics and duration of drop-off wait times for each of the 975 trips described in the above example, durations for other service types may also be recorded, such as pick-up wait durations, re-fueling durations (if any), and/or cleaning duration (if any), for example.

In some embodiments, the method 200 includes receiving (260) a plurality of trip characteristics for the first trip. The first configurable service time expectation is determined based on the plurality of trip characteristics of the first trip. For example, a requested trip may have the following trip characteristics: pick-up time=4:45 AM, pick-up location type=city, drop-off location type=airport, rider age=57, rider gender=female, rider requires special assistance?=no. A pick-up wait time expectation may be determined to be 30 seconds based on the time of day (e.g., early in the morning) and the pick-up location type (e.g., city). In contrast, a cleaning time expectation may be determined to be 10 minutes based on the drop-off location type (e.g., airport, no idling allowed).

In some embodiments, the method 200 includes receiving (262) a trip characteristic for a second trip that is distinct from the first trip. The trip characteristic for the second trip is distinct from the trip characteristic of the first trip. The method 200 also includes determining (264) a second configurable service time expectation for the second trip based at least in part on the trip characteristic of the second trip. The first configurable service time expectation and the second configurable service time expectation correspond to a same service type and the determined second configurable service time expectation is different from the determined first configurable service time expectation. For example, a first trip may have a trip characteristic that includes a trip location in Dallas, Tex. and a second trip may have a trip characteristic that includes a trip location in Pittsburgh, Pa. A pick-up wait time expectation may be determined based on the city in which the trip is occurring. Thus, a pick-up wait time expectation may be determined to be 5 minutes and a pick-up wait time expectation for the second trip may be determined to be 3 minutes.

In some embodiments, the method 200 includes receiving (270) a first user preference indicating a first duration for the first configurable service time expectation for vehicles of a first fleet and assigning (272) vehicles of the first fleet to have the first configurable service time expectation corresponding to the first duration. The method 200 also includes receiving (274) a second user preference indicating a second duration for the first configurable service time expectation for vehicles of a second fleet that is distinct from the first fleet. The second configurable service time expectation corresponds to a same service type as the first configurable service time expectation. The second duration is different from the first duration. The method 200 also includes assigning (276) vehicles of the second fleet to have the second configurable service time expectation corresponding to the second duration. For example, a fleet manager for a first fleet of vehicles that are designed to be accessible to passengers that require special assistance may assign vehicles in the first fleet to have a drop-off wait time of 5 minutes to account for any special assistance each passenger may need, such as a wheelchair ramp or being helped to their door. In contrast, a fleet manager for a second fleet of vehicles that do not have capabilities to accommodate passengers with special assistance and only operates in a city environment may set a drop-of wait time of 15 seconds as most drop-offs are in non-sanctioned parking spots (e.g., in front of a fire hydrant, double parked, etc.).

In some embodiments, the method 200 includes receiving (280) a first user preference indicating a first duration for a first service type for vehicles of a first fleet and assigning (282) vehicles of the first fleet to have the first configurable service time expectation, for the first service type, that corresponds to the first duration. The method 200 also includes receiving (284) a second user preference indicating a second duration, different from the first duration, for the first service type for vehicles of the first fleet and updating the first configurable service time expectation to correspond to the second duration. For example, a fleet manager of a fleet of vehicles may set a refueling service duration of 10 minutes for re-fueling a vehicle. However, since the fleet mostly operates in rural areas, drivers usually need to drive at least 5-10 minutes to a nearest gas station. Based on this feedback, the fleet manager may change the refueling service duration to be 15 minutes. The refueling service time expectation is updated, from 10 minutes to 15 minutes, based on the changes made by the fleet manager.

In accordance with some embodiments, the method 200 further includes receiving querying (290) a curated set of parking spots to find one or more first parking spots corresponding to the requested pick-up location, and (292) assigning a first parking spot of the one or more first parking spots as the pick-up location for the first passenger. The method 200 also includes querying (294) the curated set of parking spots to find one or more second parking spots corresponding to the requested drop-off location, and assigning (296) a second parking spot of the one or more second parking spots as the drop-off location for the first passenger. Thus, routing the first vehicle to the pick-up location includes routing (298) the first vehicle to the first parking spot and routing the first vehicle from the pick-up location to the drop-off location includes routing the first vehicle from the first parking spot to the second parking spot.

In some embodiments, the method 200 further includes receiving a requested pick-up location for a first passenger of the new trip, querying a curated set of parking spots to find one or more first parking spots corresponding to the requested pick-up location, and assigning a first parking spot of the one or more first parking spots as the pick-up location for the first passenger. The method 200 also includes receiving a requested drop-off location for the first passenger of the new trip, querying the curated set of parking spots to find one or more second parking spots corresponding to the requested drop-off location, and assigning a second parking spot of the one or more second parking spots as the drop-off location for the first passenger. The method 200 further includes assigning a vehicle of the fleet of vehicles to the new trip and routing the vehicle for the first trip, including routing the vehicle to pick-up the first passenger at the assigned pick-up location and routing the vehicle to drop-off the first passenger at the assigned drop-off location. For example, a user may request a ride from a suburban neighborhood to a busy downtown location. The fleet planner queries a curated set of known parking spots that is provided by the fleet manager to find parking spots to stop the vehicle for picking-up and dropping-off the passenger. The fleet planner identifies a parking lot for a public park on the same block as the requested pick-up location of the user and navigate the vehicle to pick-up the passenger at a specific parking spot in the identified parking lot of the public park. The passenger's pick-up location is updated and presented to the passenger so that the passenger can meet the vehicle at the designated parking spot. The fleet planner also identifies, from the curated set of known parking spots, a curb-side pick-up/drop-off location in near the passenger's destination. The fleet planner routes the vehicle to the identified pick-up/drop-off location, allowing the passenger to safely exit the vehicle in a busy downtown area.

In some embodiments, the method further includes, prior to querying the curated set of parking spots, generating the curated set of parking spots. Generating the curated set of parking spots includes collecting data (e.g., directly via first party processes or from third party partners) on parking spots, and generating a data store (e.g., a common data store) that includes information regarding the parking spots. For example, the data store may include, for each parking spot, information regarding any of: location, operational hours, characteristics (e.g., handicapped spot, electric vehicle or carpool only spot, limited parking time, loading-only spot, user must use stairs to access), owner (e.g., privately owned by company A, is a spot in a private parking garage, is a public spot), and popularity of the spot (e.g., in a densely populated area that has lots of pedestrian and vehicular traffic, or in a remote area that is not very popular). In some embodiments, generating the curated set of parking spots also includes performing a quality assessment on the data to remove and/or correct bad, incomplete, or incorrect data.

In some embodiments, the curated set of parking spots includes parking spots that have been identified based on historical data. For example, the curated parking spots may include parking spots that have been known to be available during past trips or known to be available during specific dates and/or times.

In some embodiments, the curated set of parking spots includes parking spots that have been identified by one or more images captured by a vehicle of the fleet of vehicles. For example, the curated parking spots may include parking spots that are identified via an image captured by an automatic vehicle while driving down a street.

In some embodiments, the method further includes selecting the first parking spot of the one or more first parking spots as the pick-up location for the first passenger and selecting the second parking spot of the one or more second parking spots as the drop-off location for the first passenger. The first parking spot is selected based at least on a proximity of the first parking spot to the requested pick-up location and the second parking spot is selected based at least on a proximity of the second parking spot to the requested drop-off location. For example, a curated parking spot that is determined to be closest to the requested pick-up location is selected and assigned as the pick-up location. In another example, a curated parking spot that is determined to have the shortest walking routing distance to the requested pick-up location is selected and assigned as the pick-up location.

In some embodiments, each parking spot of the curated set of parking spots includes one or more characteristics. The first parking spot is assigned based at least on a characteristic of the first parking spot and the second parking spot is assigned based at least on a characteristic of the second parking spot. For example, if a passenger identifies that the passenger requires a wheelchair accessible vehicle, the curated parking spots selected for the pick-up location and drop-off location are selected because they are determined to be (e.g., has a characteristic of being) wheelchair accessible. In some embodiments, the selected parking spots may not be the closest in proximity to the requested pick-up location and drop-off location but are selected due to the parking spots having a characteristic that matches a preference or requirement provided by the passenger.

In some embodiments, the method also includes determining whether a respective parking spot is available to be used as a pick-up or drop-off location. In accordance with the determination that a respective parking spot is available (and in some cases, matches other criteria), the available parking spot is assigned as a pick-up or drop-off location.

In some cases, determining whether a respective parking spot is available to be used as a pick-up or drop-off location include accessing historical data corresponding to a respective parking spot and determining a probability (e.g., likelihood) that the respective parking spot is available (e.g., not occupied, not in use, accessible). Alternatively or in addition to accessing historical data, the method may include determining whether or not a respective parking spot is available based on one or more cameras associated with vehicles in the fleet of vehicles. For example, if an estimated pick-up time is 11:50 am, the fleet manager may automatically access a live stream, a video recording, or image(s) captured by a camera of a vehicle of the fleet that drove by the parking spot assigned for the pick-up at a time close to 11:50 am (e.g., within a time window of 5 minutes before the pick-up time). Using the information captured by the camera of the vehicle that recently drove by the assigned, parking spot, the fleet manager can determine whether the assigned parking spot is available and update routing of the first vehicle if needed (e.g., update routing to a different pick-up location if the assigned parking spot is determined to be unavailable). In some embodiments, this process is performed after querying the curated set of parking spot and prior to assigning a parking spot as a pick-up or drop-off location. In some embodiments, this process is performed after querying the curated set of parking spots and after assigning the first parking spot as a pick-up location. In some embodiments, this process is performed in real time.

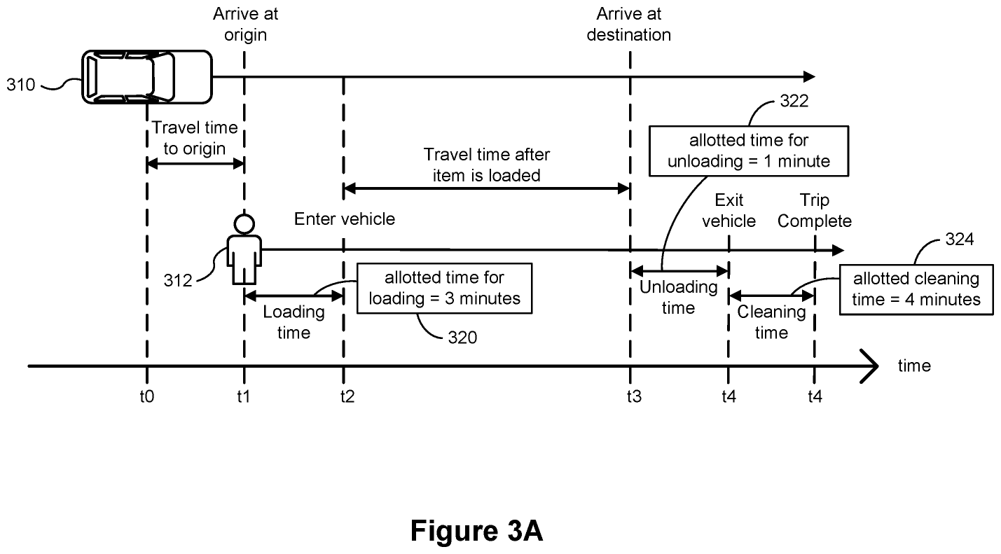

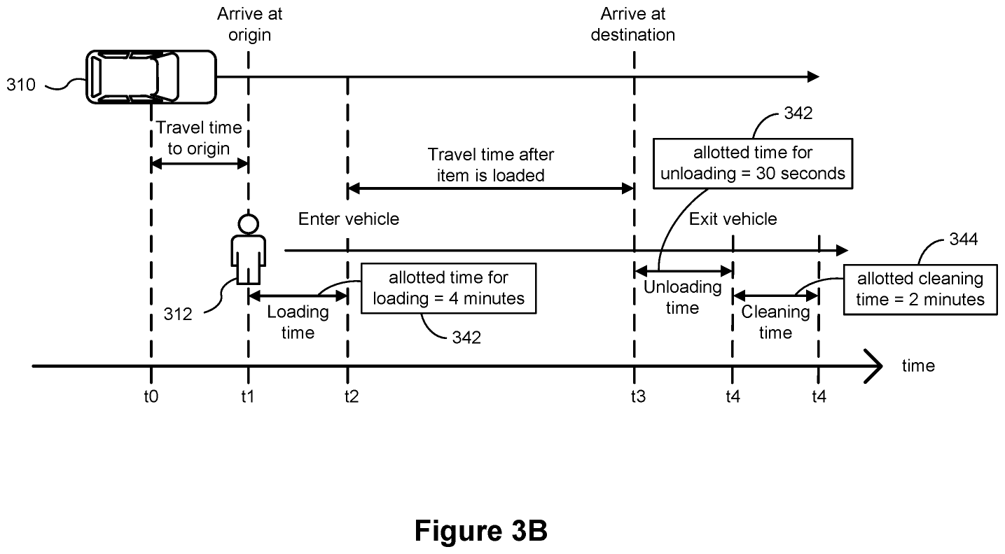

FIG. 3A illustrates a timeline with customizable steps and times, in accordance with some embodiments. The timeline corresponds to steps taken within each trip that is completed by a vehicle of a fleet of vehicles. For example, the timeline corresponds to a trip request that is received from a user. The dispatching service dispatches vehicle 310 of a fleet of vehicles to complete the trip. The vehicle 310 is dispatched at t0 and the vehicle 310 arrives at the origin at time t1. In this example, the allotted time 320 for passenger loading (e.g., time allotted for waiting for passenger(s) 312 to enter the vehicle 310, step 162) is 3 minutes. Thus, the vehicle 310 is expected to depart from the origin (e.g., pick-up location) at a time, t2, that is less than 3 minutes later than the time of arrival at the origin, t1. After passenger loading is complete, the vehicle 310 navigates to the destination (e.g., drop-off location) at a time, t3. In this example, an allotted time 322 for unloading passengers 312 (e.g., time allotted for waiting for passenger(s) to exit the vehicle 310, step 172) is 1 minute. After all passengers have exited the vehicle, this timeline includes an optional step for cleaning the vehicle (e.g., step 174). The allotted time 324 for cleaning the vehicle 310 (e.g., time allotted for cleaning the vehicle, step 174) is 4 minutes. After the vehicle 310 is cleaned (e.g., in step 174), the trip is considered to be complete at time, t4, and the vehicle 310 is ready to begin another trip. Note that, by more accurately estimating the over all trip time, the ability to dispatch vehicles (e.g., before they have completed a previous trip) is improved.

In some embodiments, the allotted times (e.g., allowed times) for one or more steps within the timeline are determined (e.g., set, predefined) by a fleet manager who manages the fleet of vehicles. For example, the fleet manager may determine that all trip timelines have an allotted time 322 of 1 minute for unloading passengers. In some cases, the allotted time for a particular step may vary for different vehicles or different trip types. For example, the fleet manager may determine that timelines corresponding to ride-hail trips have an allotted time of 3 minutes for loading passengers and that timelines corresponding to ride-share trips have an allotted time of 2 minutes for loading passengers. In another example, the fleet manager may determine that timelines corresponding to trips that have a transportation port (e.g., train terminal, airport) have an allotted time of 3 minutes for unloading passengers since trips with destinations at a transportation port tend to include passengers with luggage and thus, the passengers may require more time to exit the vehicle and unload their luggage compared to trips with other types of destinations.

FIG. 3B illustrates updating customizable steps and times in the timeline shown in FIG. 3A based on historical information, in accordance with some embodiments. The timeline of a trip to be completed by a vehicle 310 of a fleet is updated based on historical information on trips that have been completed by vehicles of the same fleet. For example, the historical information may show that most passengers (e.g., >80% of passengers) take less than one minute to exit a vehicle with an average time of 19 seconds. Thus, the historical information may be used to update the allotted time 322 for passenger unloading in accordance with the historical information (e.g., the allotted time 322 for passenger unloading is updated based on the historical information on trips that were previously completed by vehicles of the same fleet).

In this example, the updated allotted time 340 for passenger loading is updated from the original allotted time 320 for passenger loading to 4 minutes based on historical information indicating that the passengers generally need more time than previously allowed for loading. The updated allotted time 342 for passenger unloading is also changed from the original allotted time 322 for passenger unloading based on historical information, which indicates that passengers do not need as much time as previously allotted. Thus, the updated allotted time 342 for passenger unloading is 30 seconds, compared to the original allotted time 322 for passenger unloading of 1 minute. The allotted time 324 for cleaning the vehicle has also been has updated based on historical information. In this example, historical information indicates that drivers take an average of 2 minutes to clean the vehicle 310 between trips. Thus, allotted time 324 for cleaning the vehicle is changed to an updated allotted time 344 of 2 minutes for cleaning the vehicle.

FIGS. 4A-4B are block diagrams illustrating an architecture of a vehicle routing engine, in accordance with some embodiments. For example, the client 430 is the vehicle (e.g., an autonomous vehicle or an electronic device associated with the autonomous vehicle, a non-autonomous vehicle, a tele-operated vehicle such as a delivery robot) to be routed. In another example, the client 430 is a fleet of vehicles that is managed (e.g., operated) by a fleet manager.

Real-time data updates 440 include a server system that receives and/or tracks real-time traffic 442, historical traffic 444, and Events 446, and includes historical information 441, and processes and forwards the information to Routing Engine 438. In some embodiments, the Routing Engine 438 also uses the information to create and/or update a route for client 430. The Routing Engine 438 also uses information received from routing map 436 (which may include information from a road level map 432 and/or a lane level map 434) to create/update the route for client 430.

FIG. 4B illustrates another exemplary architecture (e.g., a so-called “stack”) for a fleet of vehicles. The features of the exemplary architecture shown in FIG. 4B may optionally complement, replace, or be combined with the features of the architecture described with respect to FIG. 4A. In some embodiments, the fleet of vehicles is a mixed fleet of vehicles including autonomous vehicles (e.g., autonomous vehicles 408) and non-autonomous vehicles (e.g., non-autonomous vehicles 406). In some circumstances, a fleet includes a mix of different vehicle types (e.g., automobiles, bicycles, scooters, and/or delivery robots). In some circumstances, the fleet provides services to passengers (e.g., riders/consumers 404) by transporting riders from a first location to a second location. In some circumstances, the fleet provides services to other consumers, e.g., by delivering items to the consumers (e.g., delivering meals from restaurants, delivering packages from retail stores).

To facilitate the provision of these services using a mixed fleet of vehicles, the stack includes a first server system 400 that provides fleet management services and routing information. The first server system 400 includes one or more processors (e.g., CPUs) and memory storing instructions for the modules described with reference to the first server system (e.g., the map matching/positioning module 416, the routing engine 410, the geospatial siloed databases 412, and the normalizing data schema 414). The first server system 400 interfaces with a fleet manager 403 on a second server system 402. In the exemplary architecture shown in the figure, the second server system 402 acts as a client of the first server system 400, while riders, consumers (e.g., riders/consumers 404, passengers), and vehicles (e.g., non-autonomous vehicles 406 and/or autonomous vehicles 408) act as clients of the second server system 402.

In some embodiments, the second server system 402 is a separate and distinct server system from the first server system 400. The second server system 402 includes one or more processors (e.g., CPUs) and memory storing instructions for the modules described with reference to the second server system 402 (e.g., the fleet manager 403). The instructions are executed by the one or more processors. In some circumstances, the fleet manager 403 is one of a plurality of fleet managers serviced by the first server system 400. For example, the fleet manager 403 may be a fleet manager for a specific company's fleet, and the first server system 400 may provide services to multiple companies' fleets.

The first server system 400 includes a routing engine 410 that provides routes, distances, and estimated times of arrival for autonomous vehicles 408 and non-autonomous vehicles 406. In some embodiments, a different instance of the routing engine is instantiated for each fleet.

The first server system includes one or more geospatial siloed databases 412 storing geospatial data (e.g., data stored with a corresponding geographical location, such as latitude and longitude). The geospatial siloed databases 412 include map data received from map data providers 420 (e.g., data such as streets locations/geometries, street names). An example of a Map Data Provider is OpenStreetMap. In some embodiments, the geospatial data further includes “high definition” data such as lane-level data (e.g., lane locations/geometries, information about which maneuvers are permitted from which lanes) received from the map data providers 420 for autonomous operation of autonomous vehicles 408. The geospatial data further includes data from other data providers 422, such as information received from municipalities about construction and road closures, real-time data, traffic data and other data. In addition, the geospatial siloed databases 412 store locations (e.g., map matched locations) of the vehicles in the various fleets.

In some embodiments, the geospatial siloed databases 412 store a plurality of distinct instances of data covering the same geographical region. For example, the geospatial siloed databases 412 store multiple maps (e.g., with geospatial data overlaid on those maps) covering the same region. In some circumstances, the different maps will include data appropriate to a specific fleet's vehicles (e.g., a fleet will include autonomous vehicles and delivery bots, and the geospatial siloed databases 412 will store one or more maps with information appropriate to the fleet's vehicle types). Some instances of the map may be public to any client (e.g., any fleet manager), while other versions of the map may be private to certain clients (e.g., certain fleet managers). For example, a respective fleet may license data from a respective high-definition map data provider. The data provided by the respective high-definition map data provider are thus siloed and private to the respective fleet's fleet manager (e.g., fleet manager 403).

The first server system 400 further includes a map matching/positioning module 416 that matches location data received from vehicles to a map location (e.g., a location of a map stored in the geospatial siloed databases 412). For example, some vehicles generate location data (e.g., GPS data or data from another positioning system, such as GLONASS, Galileo, or BeiDou). In some circumstances, this data is noisy and may place the vehicle away from its actual location, e.g., on a sidewalk or in a building. The map matching/positioning module 416 receives the location data from a respective vehicle (e.g., through the fleet manager 403, which interfaces with the first server system 400), matches the noisy location data to a probable road location and/or lane location and updates the “map matched” location of the vehicle in the geospatial siloed databases 412 (e.g., updates the matched position). In addition, the map matched position is provided to the fleet manager 403 for various purposes (e.g., monitoring the fleet).

As noted above, the stack includes a second server system 402, optionally distinct and separate from the first server system 400. The second server system 402 includes the fleet manager 403, which acts as a client of the first server system 400 (e.g., a client of the routing engine). The fleet manager 403 dispatches vehicles (e.g., non-autonomous vehicles 406 and/or autonomous vehicles 408), assigns routes to vehicles, and assigns staging locations to vehicles within its corresponding fleet (e.g., using information and routes provided by the routing engine). In addition, the fleet manager 403 interfaces with riders/consumers 404 (e.g., via a mobile application on the rider's smartphone or other device). The fleet manager 403 provides information such as estimated times of arrivals and trip costs to the riders/consumers 404 (e.g., passengers) via their mobile devices. In some embodiments, the fleet manager 403 also receives data such as vehicle positions (e.g., location, including optionally lane-specific location and orientation (e.g., which way the vehicle is pointing)) from the individual vehicles.

In some embodiments, an autonomous vehicle includes an autonomous vehicle (AV) platform which serves as an operating system and framework for the autonomous functionality of the autonomous vehicle. The autonomous vehicle includes one or more processors (e.g., CPUs) and memory storing instructions for the modules described with reference to the autonomous vehicle (e.g., the interface module, the AV platform, drivers for the sensors/controls). The instructions are executed by the one or more processors. An example of an AV platform is the open source Robotics Operating System. The fleet manager (e.g., fleet manager 403) interacts with the autonomous vehicles (e.g., autonomous vehicles 408) through an interface module, which is a module that runs on the AV platform to provide routes to the AV platform and receive data from the autonomous vehicle's sensors. For example, in some circumstances, the interface module is provided by the developer of the routing engine to act as a liaison between the first server system and the robotics of the autonomous vehicle. The AV platform receives sensor data from the autonomous vehicles sensor's and, in some circumstances, makes the sensor data available to the fleet manager, which can make the sensor data available further down the stack, for example, to the map matching/position module. In some embodiments, the AV platform sends commands to the autonomous vehicle's controls (e.g., acceleration commands, breaking commands, turning commands, etc.) through a drive-by-wire system.

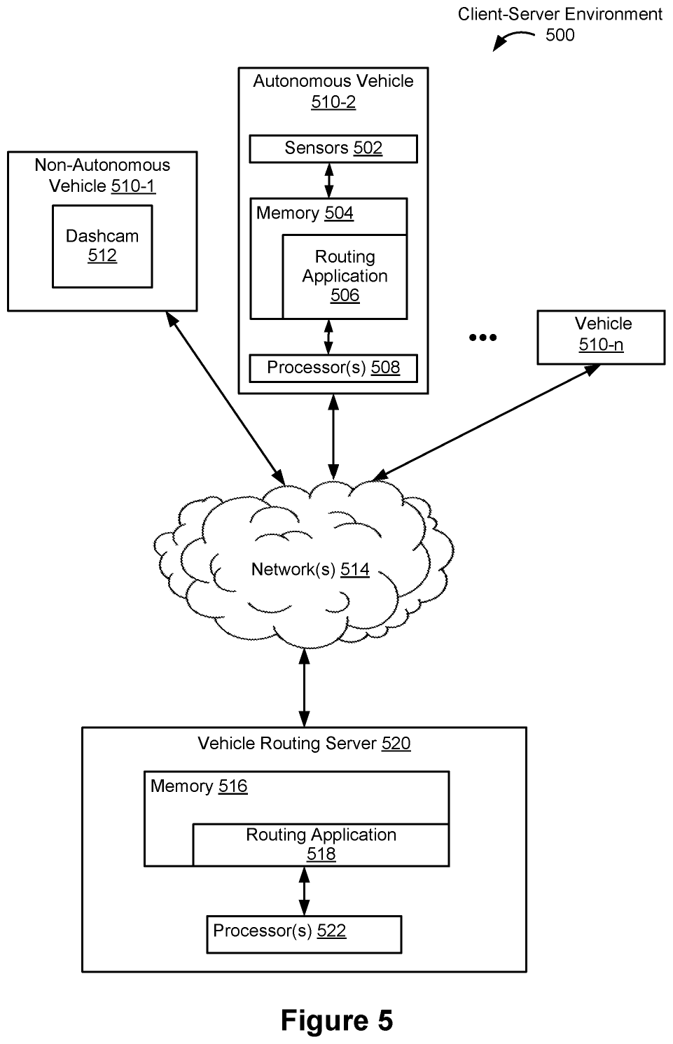

FIG. 5 is a block diagram illustrating a client-server environment, in accordance with some embodiments. The client-server environment 500 includes vehicles 510 (e.g., 510-1, 510-2, . . . , 510-n) that are connected to a vehicle routing server 520 through one or more networks 614. In some embodiments, vehicles 510 are or are analogous to vehicles 406 or 408 (shown in FIG. 4B). In some circumstances, the vehicles 510 operate as clients of vehicle routing server 520. The one or more networks 514 can be any network (or combination of networks) such as the Internet, other Wide Area Networks, Local Area Networks, metropolitan area networks, VPNs, peer-to-peer, ad-hoc connections, and so on.

The non-autonomous vehicle 510-1 is a representative human-driven vehicle (e.g., a car, truck, or motorcycle). In some embodiments, non-autonomous vehicle 510-1 is or is analogous to non-autonomous vehicle 406 (FIG. 4B) In some embodiments, non-autonomous vehicle 510-1 includes a dashboard camera 512 (e.g., dashcam 512) that acquires and sends camera images to vehicle routing server 520, which can automatically identify road conditions from dashboard camera images (as well as from autonomous vehicle camera sensor data from autonomous vehicles, such as from sensors 502 in an autonomous vehicle).

The autonomous vehicle 510-2 (e.g., a car, truck, or motorcycle) includes non-transitory memory 504 (e.g., non-volatile memory) that stores instructions for one or more client routing applications 506. In some embodiments, autonomous vehicle 510-2 is or is analogous to autonomous vehicle 408 (FIG. 4B) Client routing applications 506 are executed by one or more processors (e.g., CPUs) 508 on the autonomous vehicle 510-2. In some embodiments, the client routing applications 506 send requests for routes to the vehicle routing server 520 and receive selected routes from the vehicle routing server 520. In some embodiments, the client routing applications 506 direct the autonomous vehicles 510-2 along the selected routes. Client routing applications 506 may be embodied as any appropriate combination of programs, firmware, operating systems, or other logical or physical aspects of the autonomous vehicle 510-2. Autonomous vehicle 510-2 also optionally includes one or more network interfaces and one or more communication buses for interconnecting these components. Autonomous vehicle 510-2 further includes vehicle components, such as an engine/motor, a steering mechanism, lights, signaling mechanisms, etc., some or all of which may be under the control of programs (e.g., a client routing application 506) stored in memory 504.

In some circumstances, a fleet of vehicles e.g., up to vehicle 510-n) is in communication with vehicle routing server 520. The fleet may be a mix of autonomous and human driven vehicles or may be entirely autonomous.

Vehicle routing server 520 includes non-transitory memory 516 (e.g., non-volatile memory) that stores instructions for one or more server routing applications 518 (sometimes referred to as “routing engines”). Vehicle routing server 520 further includes one or more processors (e.g., CPUs) 522 for executing server routing applications 518. Server routing applications 518 may be embodied as any appropriate combination of programs, firmware, operating systems, or other logical or physical aspects of the autonomous vehicle 510-2. Vehicle routing server 520 also optionally includes one or more network interfaces and one or more communication buses for interconnecting these components.

The above-identified applications correspond to sets of instructions for performing functions described herein. The applications need not be implemented as separate software programs, procedures, or modules, and thus various subsets of these instructions may be combined or otherwise re-arranged in various embodiments.

It will also be understood that, although the terms “first,” “second,” etc. are, in some circumstances, used herein to describe various elements, these elements should not be limited by these terms. These terms are only used to distinguish one element from another. For example, a first vehicle could be termed a second vehicle, and, similarly, a second vehicle could be termed a first vehicle, which changing the meaning of the description, so long as all occurrences of the “first vehicle” are renamed consistently and all occurrences of the second vehicle are renamed consistently. The first vehicle and the second vehicle are both vehicles, but they are not the same vehicle (e.g., the second vehicle is an additional vehicle).

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” is, optionally, construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative embodiments. For purposes of explanation, numerous specific details were set forth in order to provide an understanding of various embodiments of the inventive subject matter. It will be evident, however, to those skilled in the art that embodiments of the subject matter are, optionally, practiced without these specific details. In general, well-known instruction instances, protocols, structures and techniques have not been shown in detail.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best use the embodiments and various embodiments with various modifications as are suited to the particular use contemplated.

1. A method of dispatching a fleet of vehicles, the method comprising:
determining a first total time expectation for a first trip for a first vehicle, wherein the first total time expectation includes a first configurable service time expectation that is different from a travel time for the first trip;
receiving one or more requests for a new trip that is different from the first trip, including receiving a requested pick-up location and a requested drop-off location corresponding to the new trip;
determining, based at least in part on the first total time expectation for the first trip, whether to assign the new trip to the first vehicle;
in accordance with a determination to assign the new trip to the first vehicle assigning the new trip to the first vehicle;
routing the first vehicle to a pick-up location corresponding to the requested pick-up location; and
routing the first vehicle from the pick-up location to a drop-off location corresponding to the requested drop-off location.

2. The method of claim 1, wherein:
determining the first total time expectation includes determining the first configurable service time expectation.

3. The method of claim 1, wherein the first configurable service time expectation corresponds to a service type that is selected from the group consisting of:
a cleaning time;
a re-fueling time;
a re-charging time;
a repair time;
a pick-up wait time;
a drop-off wait time;
a post-trip review time; and
a trip acknowledgement time.

4. The method of claim 3, further comprising analyzing historical data for a plurality of trips to determine the first configurable service time expectation, the analyzing comprising:
for a respective trip of a plurality of trips:
observing a respective duration for the service type; and
observing a trip characteristic for the respective trip;
determining a correlation between the trip characteristic and observed durations for the service type; and
determining, for the first trip, the first configurable service time expectation based at least in part on a trip characteristic of the first trip.

5. The method of claim 1, further comprising:
receiving a plurality of trip characteristics for the first trip, wherein the first configurable service time expectation is determined based on the plurality of trip characteristics of the first trip.

6. The method of claim 1, further comprising:
receiving a trip characteristic for a second trip, wherein:
the second trip is distinct from the first trip; and
the trip characteristic for the second trip is different from the trip characteristic of the first trip; and
determining a second configurable service time expectation for the second trip based at least in part on the trip characteristic of the second trip, wherein:
the first configurable service time expectation and the second configurable service time expectation correspond to a same service type; and
the second configurable service time expectation is different from the first configurable service time expectation.

7. The method of claim 1, wherein the first configurable service time expectation is determined based on historical data.

8. The method of claim 1, wherein the first configurable service time expectation is generated by a model that is trained using historical data.

9. The method of claim 1, wherein the first configurable service time expectation is determined from a user preference.

10. The method of claim 1, further comprising:
receiving a first user preference indicating a first duration for the first configurable service time expectation for vehicles of a first fleet;
assigning vehicles of the first fleet to have the first configurable service time expectation corresponding to the first duration;
receiving a second user preference indicating a second duration for a second configurable service time expectation for vehicles of a second fleet, wherein:
the second configurable service time expectation corresponds to a same service type as the first configurable service time expectation; and
the second duration is different from the first duration; and
assigning vehicles of the second fleet to have the second configurable service time expectation corresponding to the second duration.

11. The method of claim 1, further comprising:
receiving a first user preference indicating a first duration for a first service type for vehicles of a first fleet;
assigning vehicles of the first fleet to have the first configurable service time expectation, for the first service type, that corresponds to the first duration;
receiving a second user preference indicating a second duration for the first service type for vehicles of the first fleet, the second duration being different from the first duration; and
updating the first configurable service time expectation for the first fleet so that the first configurable service time expectation corresponds to the second duration.

12. The method of claim 1, further comprising:
determining an estimated end time for the first trip, wherein the estimated end time is determined based at least in part on the first configurable service time expectation.

13. The method of claim 1, further comprising:
in response to a determination to assign the new trip to the first vehicle:
generating an estimated start time for the new trip that is based at least in part on the first total time expectation for the first trip.

14. The method of claim 13, further comprising:
routing a plurality of vehicles in a fleet, comprising:
routing the first vehicle based on characteristics of the new trip.

15. The method of claim 14, wherein routing a plurality of vehicles in the fleet further includes routing a second vehicle after assigning the new trip to the first vehicle.

16. The method of claim 1, further comprising:
querying a curated set of parking spots to find one or more first parking spots that are proximate to the requested pick-up location;
assigning a first parking spot of the one or more first parking spots as the pick-up location for the new trip;
querying a curated set of parking spots to find one or more second parking spots that are proximate to the requested drop-off location;
assigning a second parking spot of the one or more second parking spots as a drop-off location for the new trip, wherein:
routing the first vehicle to the pick-up location includes routing the first vehicle to the first parking spot; and
routing the first vehicle from the pick-up location the drop-off location includes routing the first vehicle from the first parking spot to the second parking spot.

17. A computer system, comprising:
one or more processors; and
memory storing one or more programs, the one or more programs storing instructions that, when executed by the one or more processors, cause the one or more processors to perform a method comprising:
determining a first total time expectation for a first trip for a first vehicle, wherein the first total time expectation includes a first configurable service time expectation that is different from a travel time for the first trip;
receiving one or more requests for a new trip that is different from the first trip, including receiving a requested pick-up location and a requested drop-off location corresponding to the new trip;
determining, based at least in part on the first total time expectation for the first trip, whether to assign the new trip to the first vehicle;
in accordance with a determination to assign the new trip to the first vehicle assigning the new trip to the first vehicle;
routing the first vehicle to a pick-up location corresponding to the requested pick-up location; and
routing the first vehicle from the pick-up location to a drop-off location corresponding to the requested drop-off location.

18. A non-transitory computer readable storage medium storing instructions that, when executed by a computer system having one or more processors, cause the computer system to perform a method comprising:
determining a first total time expectation for a first trip for a first vehicle, wherein the first total time expectation includes a first configurable service time expectation that is different from a travel time for the first trip;
receiving one or more requests for a new trip that is different from the first trip, including receiving a requested pick-up location and a requested drop-off location corresponding to the new trip;
determining, based at least in part on the first total time expectation for the first trip, whether to assign the new trip to the first vehicle;
in accordance with a determination to assign the new trip to the first vehicle assigning the new trip to the first vehicle;
routing the first vehicle to a pick-up location corresponding to the requested pick-up location; and
routing the first vehicle from the pick-up location to a drop-off location corresponding to the requested drop-off location.
